(19) United States
(12) Patent Application Publication
(10) Pub. No.: US 2007/0156445 A1
(43) Pub. Date: Jul. 5, 2007

(54) CHARTER SYSTEM AND METHOD FOR PURCHASING AND QUALIFYING A DISTRIBUTOR POSITION IN A MULTI-LEVEL MARKETING BUSINESS

(76) Inventors: Mark Manuel, Franklin, TN (US); Greg Manuel, Franklin, TN (US)

Correspondence Address: ADVANTIA LAW GROUP, 9035 SOUTH 1300 EAST, SUITE 200, SANDY, UT, 84094, US

(21) Appl. No.: 11/618,052

(22) Filed: Dec. 29, 2006

Related U.S. Application Data
(60) Provisional application No. 60/755,400, filed on Dec. 30, 2005.
(60) Provisional application No. 60/755,496, filed on Dec. 30, 2005.

(51) Int. Cl. G06Q 99/00

(52) U.S. Cl. 705/1

(57) ABSTRACT

A system and method for purchasing a distributor position in a multi-level marketing business. The system includes: a multi-level distribution channel, having a distributor position and a management position that forms a business organization; an inclusion instrument configured to include an entity as a distributor in the distributor position; and a promotion instrument configured to promote the distributor from the distributor position to the management position in exchange for a user-selectable option of consideration. The method comprises the steps of: providing an inclusion instrument; including the entity as a distributor; receiving an option of consideration from the distributor; promoting the distributor from a distributor position to a management position; assigning a management responsibility; providing a manager with an increased access to potential revenue; restructuring a business to include a distributor position and a management position; and distributing portions of a profit to the distributorship position, management position, and business organization.

### CROSS-REFERENCE TO RELATED APPLICATIONS

This invention claims priority, under 35 U.S.C. § 120, to the U.S. Provisional Patent Application No. 60/755,496 to Greg Manuel and Mark Manuel filed on Dec. 30, 2005, which is incorporated by reference herein.

### BACKGROUND OF THE INVENTION

1. Field of the Invention

The present invention relates to multi-level marketing business systems and methods, specifically to a system and method for purchasing a distributor position in a multi-level marketing business.

2. Description of the Related Art

Entrepreneurs and individuals attempting to develop businesses have a great need for capital and other resources to operate, expand, and otherwise grow their business. To satisfy this need, many have to present detailed business plans, debt retirement plans, etc. to financial lending institutions as a prerequisite to borrow monetary funds at relatively high interest rates in exchange for the institution accepting a relatively high risk to lend funds to an unproven business entity. Others have to draw from their bank accounts and/or capital gains from real estate or security investments to generate funds needed to attain the necessary capital and resources as a means to invest in the development of their businesses. Without generating sufficient revenues to cover the cost of operating a business, the business may become overwhelmed in debt over a period of time and eventually cease to operate. There are many observed, televised and documented cases in the world where individuals have attempted to develop business, but within a few years, their businesses become defunct due to the lack of insufficient business startup funds and revenues coupled with high operating costs.

Successful entrepreneurs can testify that an effective marketing strategy or plan is very essential if one desires to attract willing and able consumers and/or clients to purchase their product or service; as well as succeed in owning, operating, and maintaining a business. However, it can be costly to a business owner to create/implement a business marketing strategy as it may cost an enormous amount of money to advertise/promote a product or service to a large population of potential consumers, through various mediums such as Internet, radio, television, newspapers, direct mail, etc.

Desiring to reduce the cost of marketing their businesses to the public, many entrepreneurs experienced that marketing a product or service to a large population of people can be accomplished quickly through network marketing by word of mouth, at little to no cost, while generating more sales and revenues. For example, if a consumer is satisfied with a given product or service, he or she would communicate their pleasurable experience and satisfaction to their contacts, family members, close friends, and other people whom they well. In turn, these additional people may be tempted to purchase the product or service. Assuming these people also enjoy the product or service, they would relay their experiences to even more people whom they know well and so forth. In the end, business owner would receive increased business opportunities through customer/client referrals.

There are an increasing number of individuals who desire or dreams of starting up and managing their own businesses instead being an employee working for someone else for undesirable compensation. What is needed is a relatively low cost, effective, and efficient method to help little to motivated individuals to become entrepreneurs without having to suffer through daunting process of attaining a business loan at high interest rates, and waiting a for a long period of time to become experienced in business ownership and generating revenues. Some improvements have been made in the field. Examples include but are not limited to the references described below, which references are incorporated by reference herein:

U.S. Pat. No. 6,922,677, issued to Sperandeo, discloses a unitary investment instrument combining a swap and a structured note, both of which provide multiple utilization of capital. The unitary instrument has three performance components. An investor invests in the issuer the principal amount of the structured note component. The structured note provides its own portfolio exposures as well as serving as collateral for the base benchmark portfolio swap (alternatively, the base benchmark portfolio exposure can be acquired through a separate collateral deposit on the investor's own portfolio). The first component is a benchmark portfolio, which in one preferred embodiment is a financial or stock index such as the S&P 500 Stock Index. The second component is an incremental benchmark portfolio keyed to the same benchmark index and the third component is keyed to a passive commodity index, having long and short positions, which in one preferred embodiment is the Mount Lucas Management Commodity Index. The instrument's passive commodity index exposure is established as the product of a leverage factor and the amount of the benchmark portfolio exposure; thereafter this exposure may be the product of (1) a leverage factor and/or (2) the change in value of the overall investment, the benchmark component and/or the commodity index component. The basic return to the investor comprises the change in value of the benchmark, the incremental benchmark and the passive commodity index exposure over a predetermined period of time. The structured note component of the investment instrument includes a guarantee of the return of the investment principal; the swap does not do so, but rather reflects the full risk of the benchmark portfolio exposure.

US Patent/Application No.: 2005/0182702, by Williams, III, discloses a Systems and methods are provided that allow a financial instrument to be structured so that the underlying borrowed principal is callable, putable, or both. In a preferred embodiment, a Range Accrual Mortgage is structured so that the underlying borrowed principal is a mortgage that is callable, putable, or both by embedding into the loan structure a rate put option. Systems and methods according to the invention lend symmetry to the interest rate behavior of certain borrowings by making explicit the pricing and market value of options that were previously only implicit in the borrowing structure. For example, a mortgage in accordance with the invention should provide incentives for either the homeowner or the bank to refinance the mortgage and should do so whether interest rates rise or fall, and no matter what path interest rates follow from the inception of the instrument until the maturity of the instrument. The invention achieves the desired advantages, in part, by extending the characteristics of a borrowing via the addition of a rate put option on an interest rate and, in part, by permitting correlative adjustments to the outstanding loan principal.

US Patent/Application No.: 2004/0215542, by Rossides, discloses a method for enabling a seller to pay micro-commissions to one or more individuals who deliver a sales message to a prospect. For example, a toy manufacturer might offer to pay people who ask a retailer to stock a particular toy. If the retailer buys the toy then a commission is owed to this group of “grassroots ” referrers. Each referrer's share of the commission may be very small, a micro-commission. The method comprises a set of steps executed by a computer database system interacting with users. In simplified form the steps are: (1) a seller enters a referral offer into the system, (2) referrers then enter referral claims that identify a prospect and that represent claims on a potential commission, (3) the expected value (EV) payment process of U.S. Pat. No. 5,269,521 is used to “probabilistically amplify ” the commission owed through a fair bet, (4) if a claim “wins” the EV payment bet process, the amplified commission is calculated and an inspector verifies the winning claim, (5) then, if the claim is found valid, the referrer who submitted the claim is paid his share of the amplified commission. In addition, the method can be modified to enable a buyer to submit a claim that a referral has been made by an individual leading to a sale. In addition, the method can be modified enable a buyer to submit a claim that a referral has been made via a medium leading to a sale to the buyer. The method is further modified to enable the medium's owners to be paid, and to enable an individual making a referral in a medium to be paid for that referral.

US Patent/Application No.: 2003/0125964, by Chang et al., discloses a system and a method for tracking marketers/distributors of a digital product is provided, using a multi-level marketing business model, including the steps of storing user data associated with a plurality of registered users, wherein said user data includes a user identification code (userID) corresponding to each registered user of the plurality of users; transferring a data packet associated with the digital product by a registered user of the plurality of registered users to another user, wherein the data packet includes a watermark storing the userID of the registered user; and updating the watermark to include the userID of the registered user who transferred the data packet; and processing payment information corresponding to the registered user who transferred the data packet for effecting payment to the registered user for the sale of the digital product by the registered user to the user.

US Patent/Application No.: 2003/0158796, by Balent, discloses a business method utilizing a system comprising one or more distributed computers, application software, off-the-shelf peripheral components including keyboard-and-mouseless data entry (KDE) devices, business processes, human and KDE device readable data, related information on removable data storage media or available from external databases, and existing communications systems for speeding and improving: 1) personal or business automation, efficiency and productivity, goal attainment; 2) improving, speeding and automating the person-computer interface; 3) selection, acquisition, and tracking usage of items acquired from an existing supply chain; 4) marketing items and retaining customers buying the products, controlling their usage, and disseminating information about the products.

US Patent/Application No.: 2003/0167175, by Salom, discloses a method of generating a new enterprise is based on forming a holding company that includes existing enterprises. Intellectual property (IP) assets are developed within the existing enterprises and are deposited in a common database owned by the holding company. New products and market opportunities are developed for at least one of the developed IP assets within at least one of the existing enterprises. The management team of the holding company come together with the management teams of the existing enterprises decide whether to form a new enterprise based on the developed new products and market opportunities. After the decision is made to form a new enterprise financing is secured for the formation of the new enterprise, a management team is provided for managing said new enterprise and a new enterprise is formed.

US Patent/Application No.: 2003/0083914, by Marvin, III, et al., discloses a business development process utilizing a business development database comprises collecting data for ideas from a plurality of sources. One type of collected idea data from said step of collecting is filtered in order to identify potential business opportunities. An opportunity analysis is then performed on said identified potential business opportunities to determine valid business opportunities. Resources are committed to the valid business opportunities, a business proposal is developed. This developed business proposal to a potential buyers. Success of the submission is determined and the business opportunity is executed if the submission is a success.

US Patent/Application No.: 2002/0065753, by Schloss et al., discloses a financing enterprise cooperatively owned by at least three originators of financial instruments, no single originator owning 50% or more of the financing enterprise. The originators and financing enterprise cooperatively specify underwriting standards for financial instruments. The financing enterprise purchases financial instruments from the originators and aggregates them into pools for resale in the financial markets. No single originator has 50% or more representation in any pool. The financing enterprise only purchases financial instruments conforming to the underwriting standards, though the originators are free to originate other financial instruments, and financing enterprise is not bound to purchase all financial instruments tendered by the originators. The financing enterprise may offer the financial instruments in the form of structured securities backed or secured by the financial instruments. The securities include a first loss piece. The financing enterprise and securities offered by the financing enterprise are structured to entirely transfer default risk from the originators to purchasers and to terminate the moral recourse obligation historically imposed by rating agencies.

US Patent/Application No.: 2002/0161644, by Duffield, discloses a cooperative incentive and promotion system and method encouraging subscription to electronic presentment and payment (EPP) vendor services, such as electronic bill presentment and payment (EBPP) and/or electronic statement presentment (ESP) services, wherein a consumer engaging in a bill paying or printed statement review process is induced to access a global networking system, such as the Internet, during that process. Positive inducement is provided on a bill or statement envelope, a remittance envelope, directly on the bill or statement or on an insert therewith, wherein a sweepstakes offer, coupon or discount offer promoting a specific business, product or service is prominently displayed, wherein access to the Internet is required and utilized for receipt thereof, and wherein coincident promotion of EBPP and/or ESP subscription is provided.

US Patent/Application No.: 2001/0023407, by Liyanearachchi et al., discloses a method and system for distributing promotional offers and other incentives to consumers over a communication network and for the consumers subsequently to redeem at least some of the offers is disclosed. The invention includes storing manufacturers offers and/or retail incentives in a database C associated with a co-operative communication network site 2 and providing information from the database to a consumer in a response to a request from a consumer to the database. The consumer may be connected directly to the database or may be given access to the database while logged into a retailer's or manufacturer's network site in such a way that the consumer is not aware that information is coming from the co-operative communication site. In addition, a transactional second database D is provided for recording transactions on the first database C so that when a consumer selects offers, from the database, an order is generated, on the transactional database. This order is passed to the retailer's on-line check out and the transactional database is further updated with any unfulfilled orders. Invoicing data is then produced from the transactional database for invoicing manufacturers and other suppliers for manufacturer's offers redeemed by retailers, and in addition, in an embodiment of the invention, marketing analysis reports are generated from the transactional database.

The inventions heretofore known suffer from a number of disadvantages which include: being unable to provide a timely means for individuals to obtain interest-free funds for business development; offering limited management opportunities; being unable to afford individuals an opportunity to become managers quickly based on performance; and/or otherwise failing to enable individuals to have sufficient control recruitment of high-motivated entrepreneurs, revenue/profit generation, and other resources.

Accordingly, there exists a need for a business system and method that solve one or more of the problems herein described or that may come to the attention of one skilled in the art after becoming familiar with this specification. Note that statements within this application are not intended to be legal advice but instead to disclose information related to the present invention.

### SUMMARY OF THE INVENTION

The present invention has been developed in response to the present state of the art, and in particular, in response to the problems and needs in the art that have not yet been fully solved by currently available business systems and/or methods. Accordingly, the present invention has been developed to provide a system and method for purchasing a distributor position in a multi-level marketing business.

There is one embodiment of a charter system for purchasing a distributor position in a multi-level marketing (MLM) business. The system may include: a multi-level distribution channel that may have a distributor position and/or second distributor position that may be a revenue position and/or a management position, wherein the distributor position and/or the management position may form a business organization; an inclusion instrument that may be associated with the distributor position, and/or may be configured to include an entity as a distributor in the distributor position; and a promotion instrument that may be associated with the management position, and/or may be to configured to promote the distributor from the distributor position to the management position, as a manager within the distribution channel in exchange for a user-selectable option of a consideration.

According to one embodiment of the present inventive system, the management position may include a higher level of responsibility than the distributor position and/or an increased access to potential revenue. Additionally, the management position may be unoccupied until the distributor is promoted to the management position.

According to another embodiment of the present inventive system, the inclusion instrument may comprise a document requesting a first disclosure of information from the entity as a prerequisite to include the entity as a distributor.

According to another embodiment of the present inventive system, the promotion instrument may include: a document requesting a second disclosure of information from the distributor, and/or a user-selectable option of consideration as prerequisites to promote the distributor from the distributor position to the management position.

According to yet another embodiment of the present inventive system, the distributor may include a business organization.

According to still yet another embodiment of the present inventive system, the consideration comprises a user-selectable option from the group consisting of: a predetermined amount of currency; and/or a predetermined amount of currency equivalent; and/or a performance requirement; and/or a service.

In still yet a further embodiment, there may be a method for purchasing a distributor position in a MLM business organization. The method may include the steps of: providing an inclusion instrument requesting a first disclosure of information from an entity; and/or including the entity as a distributor in a business; and/or receiving a user-selectable option of consideration from the distributor; and/or promoting the distributor from a distributor position to a management position as a manager upon receipt of a promotion instrument with a requested second disclosure of information from the distributor and the selectable option of consideration; and/or assigning the manager a management responsibility; and/or providing the manager with an increased access and control to potential revenue.

In still yet even a further embodiment, the method for purchasing a distributor position in a business may include the steps of: restructuring a business to include a distributor position and a management position in a business; and/or distributing a first predetermined portion of a profit to the distributorship position and/or the management position in the MLM business, wherein the first predetermined portion of a profit may be configured to increase a number of distributor positions and/or management positions; and/or reinvesting a second predetermined portion of the profit into the MLM business, wherein the second predetermined portion of the profit may be configured to stimulate growth of the MLM business.

According to one embodiment of the present inventive method, the user-selectable option of consideration may comprise: a predetermined amount of currency; and/or a predetermined amount of currency equivalent; and/or a performance requirement; and/or a service.

In another embodiment of the present inventive method, the management responsibility may include: managing a distributorship position; and/or managing a plurality of distributorship resources; and/or managing a revenue; and/or managing a profit.

In yet another embodiment of the present inventive method, the first disclosure of information and/or the second disclosure of information may comprise documented personal information.

### BRIEF DESCRIPTION OF THE DRAWINGS

In order for the advantages of the invention to be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 illustrates a block diagram of a system of purchasing a distributor position in a business organization, according to one embodiment of the present invention;

FIG. 2 illustrates a block diagram of a system of purchasing a distributor position in a business organization, according to one embodiment of the present invention;

FIG. 3 illustrates a flowchart of a method for purchasing a distributor position in a business organization, according to one embodiment of the present invention;

FIG. 4 illustrates a continuation of flowchart depicted in FIG. 3, according to one embodiment of the present invention; and

FIG. 5 illustrates a block diagram of a management structure according to one embodiment of the invention.

### DETAILED DESCRIPTION OF THE INVENTION

For the purposes of promoting an understanding of the principles of the invention, reference will now be made to the exemplary embodiments illustrated in the drawings, and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

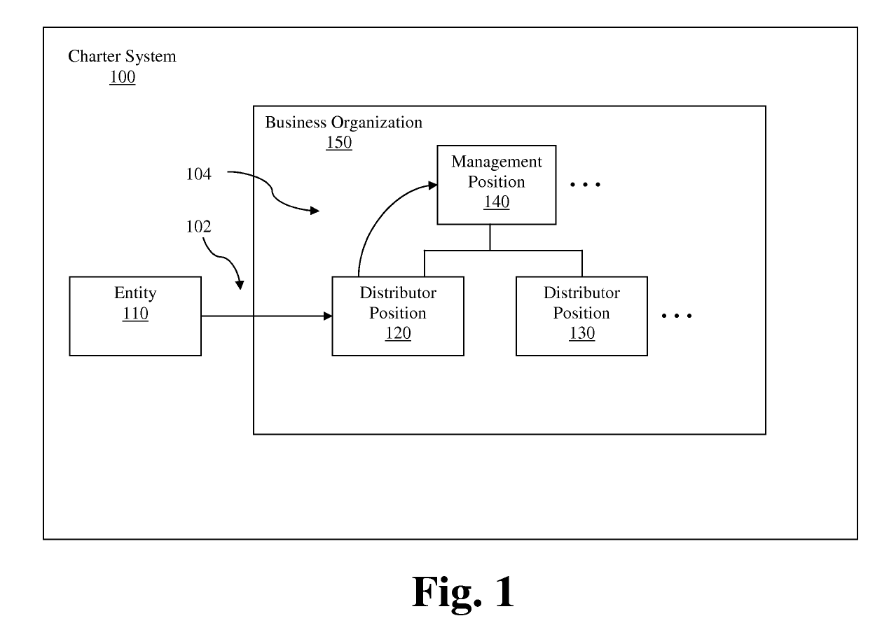

FIG. 1 illustrates a block diagram of a system of purchasing distributor to position in a business organization (charter system 100), such as but not limited to a business that utilizes a multilevel marketing distribution module (MLM), according to one embodiment of the invention. The illustrated charter system 100 may be present in a MLM type business organization 150 or may be used to convert a more traditional business organization 150, thereby enabling such to sell a distributor position that may be a charter position or revenue position. As used herein, the term revenue position includes charter, management, revenue, and any other distributor-type position having enhanced responsibilities and/or opportunities. The illustrated charter system 100 includes a management position or charter position 140 and distributor positions 120 and 130, wherein the positions 120, 130 and 140 collectively form a business organization 150 that may be a MLM business organization. Further, there is an entity 110 that enters 102 distributor position 120 (thereby becoming a distributor) then is promoted 104 to management position 140 (thereby becoming a manager). The entity 110 may be promoted 104 upon paying the business organization. When in the management position 140, the entity 110 has enhanced responsibilities and has an opportunity to receive consideration, including but not limited to participation in a revenue stream.

Advantageously, the entity 110 may provide revenue for the business organization 150, which revenue may be utilized by the business organization. Wherein the costs associated with developing the charter position 140 are generally small compared to the revenue generated thereby, the business organization 150 may use a large portion of the revenue as working capital, thereby providing an opportunity for the business organization to grow quickly where it may have otherwise had more limited resources.

The illustrated business organization 150 may be any business organization. Non-limiting examples include: partnerships, corporations, hybrid organizations, and foundations. Such may be in the business of selling goods and/or services and/or promoting other interests, such as but no limited to promoting social change. In one embodiment, a business organization is a multi-level marketing business that provides a good or service for a fee, wherein a collected fee is revenue and revenue is portioned to members according to a system of revenue distribution, such as but not limited to proportional distributions up a chain of member positions.

It is anticipated that the entity 110 is generally an individual, but it is envisioned that the entity may include a business organization or other similar organization. In one non-limiting example, an entity may be a service provider (such as but not limited to a marketing company) desiring to have a closer relationship with a client. In another embodiment, an entity 110 may include a MLM organization desiring to append itself to an existing business organization 150. Accordingly, an entity 110 may enter 102 the business organization 150 and may be promoted 104 therein.

The illustrated distributorship positions 120 and 130 are shown to be managed directly by the management position 140 and indirectly connected to each other. In particular, each of distributor positions 120 and 130 report to management position 140 without having a reporting relationship with each other. Alternatively, in another embodiment of the invention, a distributorship position and a management position may less directly connected and even may not be connected directly (there may be no responsibilities between each). As a non-limiting example, a distributor position may include a responsibility of selling a product while a management position may include a responsibility of managing new product development, wherein no further responsibilities of each relate to the other.

In the illustrated example, the management position 140 includes responsibility different or in addition to those of the distributorship positions 120 and/or 130. Responsibilities may include any responsibilities generally attributed to a position of manager and/or owner. Non-limiting examples include: instructing, oversight, evaluating performance, maintaining performance standards, problem solving, and strategic development. A management position may include a scope, such as generally seen in business organizations. Non-limiting examples include but are not limited to: manager of a geographic area, manager of a market area, manager of a product line, and manager of a process.

Receipt of consideration or other benefit by an entity in a management position may be restricted according to a performance threshold. As a non-limiting example, a management position may be entitled to participate in a revenue sharing model only when a down-line of the management position satisfies a sales volume requirement. Accordingly, the management position is required to acquire, maintain, develop, or otherwise be active in the duties and/or responsibilities of the management position in order to qualify for the benefits thereof. Receipt of consideration may be independent of profitability of the business organization. In particular, consideration may be received based on revenue and may be taken as a proportional share of revenue over which a management position is entitled to share.

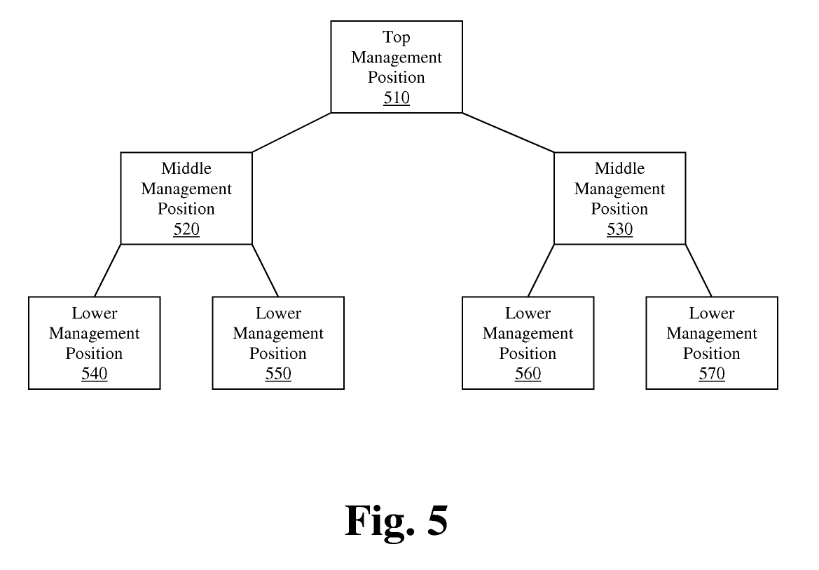

There may be a plurality of management positions (See FIG. 5). Such may be related according to a distribution model that may portion consideration from one or more revenue streams according to one or more rules. In one embodiment, a management position is responsible over a down-line in a distribution model. In another embodiment, responsibilities of a management position are not reflected by a particular position in a distribution model. Management positions 140 may be fixed in number and may be only available until filled.

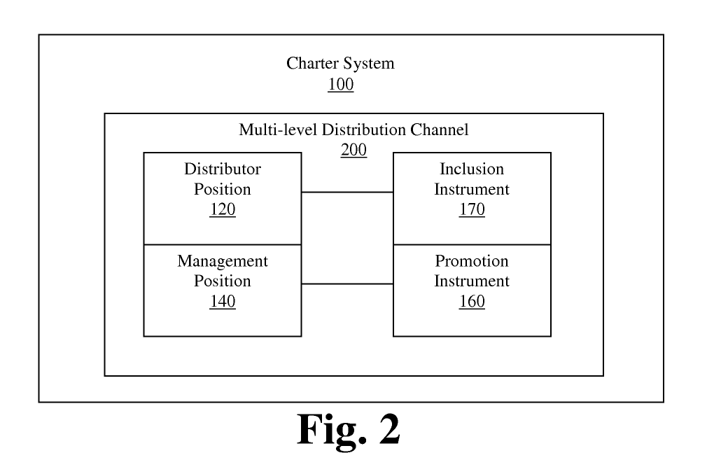

In the illustrated embodiment, an entity 110 may enter 102 a distributor position 120 by agreement (See FIGS. 2-4). The distributor position 120 may be an independent distributor position and the agreement may be such that the entity 110 may enter the distributor position 120 without providing any consideration. The distributor position 120 may include an entitlement to future conditional consideration, such as participation in a revenue sharing distribution model. In one embodiment, a distributor position 120 entitles a distributor to a portion of gross sales by the distributor and to a portion of gross sales by other distributors recruited by the distributor. A distributor position may enable a distributor to receive a benefit from a manager, such as but not limited to oversight, management, services, instruction, etc.

A distributor may be promoted 104 to a management position 140 by one or more of a plurality of paths. In one embodiment, a distributor may provide consideration in the form of conventional currency, such as U.S. dollars or dollars from a foreign country, to a MLM business owner. According to another embodiment, the distributor may provide consideration in the form of currency equivalent, such as personal checks, cashier checks, money orders, etc., in order to be promoted to the management position 140. In still yet another embodiment, the distributor may offer to provide a service in the MLM business as acceptable consideration. For example, the distributor may be an attorney opting to provide legal counsel for a MLM business in lieu of paying currency to be promoted to management. In return for legal services provided, the distributor may be promoted into a management position 140 to manage distributors under his or her tutelage, and may provide legal services to the business organization. In still yet a further embodiment, a distributor may fulfill a performance requirement as a means to pay the necessary consideration to be promoted to the management position 140. For example, a distributor selling financial products for an MLM business may be rewarded with a promotion for applying network marketing to recruit N amount of financial salespeople and selling N amount dollars worth of financial products such as life insurance, securities, etc. within a given time period set by the company.

In one embodiment, distributor position 120 may represent a significant down-line terminating in a distributor position at the bottom or distributor position 120 may be connected to management position 140 through a significant down-line. Further, distributor position 130 may represent a significant down-line full of many distributor positions. Accordingly, entering distributor position 120 may place the entity 110 at the bottom of a substantially well established multi-level marketing distribution model. Further, wherein participation in a revenue sharing model may be contingent on a volume requirement by the distributors represented by distributor positions 120 and 130, such a volume requirement may be easier to meet than without such a down-line. Accordingly, wherein the entity 110 is later promoted to management position 140, such may provide a substantial benefit to the entity 110 and may thereby be of great value to the entity 110. Further, wherein distributors may continue to recruit other distributors, a management position 140 may have an increasing value. Such a promotion 104 may cause the entity 110 to “hop” other distributors in the distribution model, such that wherein a distributor may have participated in the entity's revenue before the promotion, such may not be the case after the promotion.

FIG. 2 illustrates a block diagram of one embodiment of a charter system 100 having a multi-level distribution channel 200 with a distributor position 120, a management position 140, an inclusion instrument 170 associated with the distributor position 120, and a promotion instrument 160 associated with the management position 140. The charter system 100 is configured to enable an entity to occupy the management position 140, thereby providing benefit for a business organization utilizing the charter system 100.

The illustrated positions 120 and 140 of the charter system may be contract positions, such as but not limited to independent contractor and employment positions. The instruments 160 and 170 of the charter system 100 may be one or more documents or other instruments, such as but not limited to written legal contract(s) between a business organization and an entity. Accordingly, the positions 120 and 140 may be substantially defined by the instruments 160 and 170. Further, the instruments may reference other positions, such as but not limited to relating one or more positions to one or more other positions.

The illustrated inclusion instrument 170 is configured to include an entity as a distributor in a business organization. The inclusion instrument 170 may be an Independent Distributor Agreement. The inclusion instrument 170 may provide information about the business organization, about one or more distribution models, about distributor positions, about management positions, and etc. In various embodiments of the present invention, the instruments 160, 170 comprise written documents configured to request a first voluntary disclosure of personal information and a second voluntary disclosure of personal information from the entity and distributor, respectively. In one non-limiting example, such is without a requirement for consideration in return from the entity. Accordingly, the entity may agree to become a distributor for the business organization without having to make any purchases. The entity is free to continue as a distributor according to the position and/or the terms of the inclusion instrument 170. More, the business organization and entity may together execute a promotion instrument 160.

The illustrated promotion instrument 160 is configured to promote the distributor (entity as a distributor) from the distributor position 120 to the management position 140. In one non-limiting example, the promotion instrument 160 is a Transfer of Distributor Position Agreement. The promotion instrument 160 may identify a new position within a distribution model as the position that through the promotion instrument, the entity is to acquire. The promotion instrument 160 may include language to not reduce any obligations of the entity under a previously executed inclusion instrument 170. A entity may qualify to execute a promotional instrument 160 in a plurality of ways. In particular, an instrument (160, 170, or other) may allow an entity to execute a promotion instrument 160 wherein the entity has qualified in one or more of a plurality of ways. In one non-limiting example, a plurality of ways of qualifying the entity to execute a promotion instrument 160 includes: providing consideration to the business organization, achieving a determined level of performance as a distributor, and providing a service to the business organization. Accordingly, in one embodiment of the invention, a business organization includes a plurality of distributors, each having the potential to be promoted to a position contingent on paying consideration to the business organization, achieving a level of performance as a distributor, and/or providing a service to the business organization. Further, as other distributors are recruited, they may also be enabled to qualify to execute a promotion instrument with the business organization upon satisfying one or more conditions.

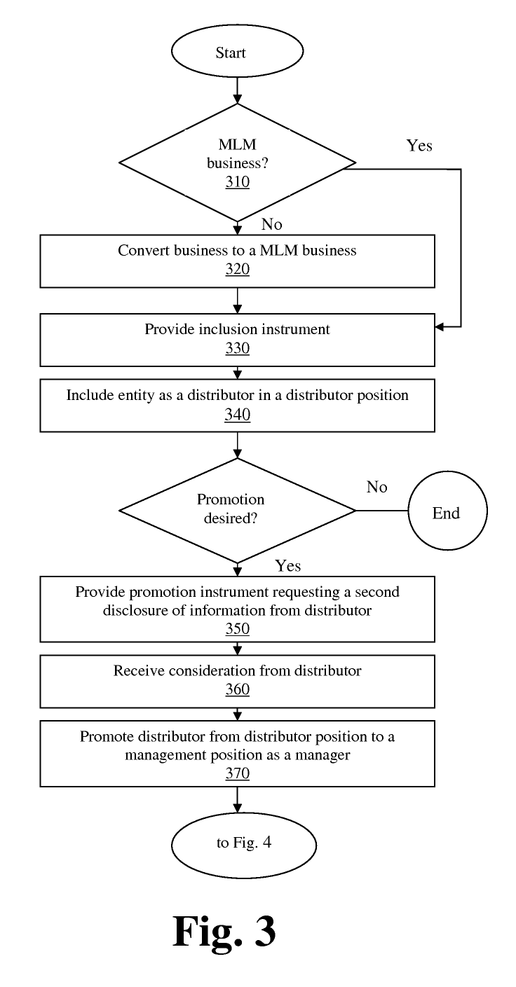

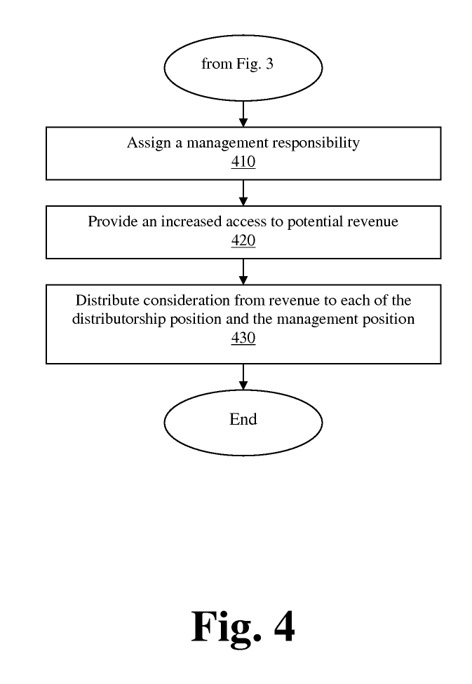

In operation of the illustrated embodiment of the present inventive method for purchasing a distributor position in a MLM business, FIGS. 3 and 4 illustrate a flowchart depicting a method of selling a revenue position in a business organization 150. The business organization may be new or already established and may be an MLM type business or otherwise. While the figures illustrate an embodiment of the invention and describe steps to be performed and ordering of steps, it is understood that variations of the illustrated method are envisioned, including but not limited to variations on step ordering and inclusion.

In the illustrated embodiment, it is desired that the business organization be a MLM type business having available distributor positions and one or more empty charter (management) positions. Accordingly, the business organization is first analyzed 310 to determine if it includes the desired structure. Where the business organization already includes the desired structure, the method skips to step 330, otherwise, the business organization is converted 320 to a MLM type business.

In converting 320, the revenue relationships of the owners of the business organization (or any other entities having rights to profit or revenue) may be restructured to provide for one or more empty charter positions. Charter positions may also be immediately filled by one or more owners or others that may have an interest in the business organization to reflect such an interest in the new structure. In one embodiment, the charter positions may be defined to reduce interference with prior ownership interests, such as but not limited to applying only to a certain region, product, process, etc; and/or defined by accounting standards that may preserve ownership interest (such as but not limited to access to profit) while offering revenue sharing to charter positions.

Further, where needed, a distribution model is put in place to provide for distribution of one or more goods and/or services of the business organization. In one embodiment, the business owners/controllers agree to amend one or more documents, such as but not limited to operating agreements and the like. In one embodiment of the invention, a charter agreement is provided by a third party, wherein the charter agreement is configured to provide desired structure within the business organization.

In one non-limiting example, the following steps may be carried out to assist a business organization in converting to a desired structure and/or implementing such structure: personal and professional contacts may be discussed, explored, mapped, and organized; conversion documents may be prepared and executed; contacts may be invited to discuss opportunity in relation to the desired structure; a charter meeting may be held wherein opportunities related to distributor positions and/or charter positions are explained; and distributor positions may be filled by contacts and later promoted to charter positions. Such may be repeated as needed to fill out empty charter positions. Accordingly, revenue and growth goals of a business may be met methodically and such may enable a business organization to leverage working capital derived from revenues.

Wherein the business organization includes the desired structure, the business organization may provide 330 an inclusion instrument to an entity. The inclusion instrument operates to allow the entity to enter an open distributorship position. Generally distributorship positions are not limited as distributor models are generally open models.

The business organization and the entity execute the inclusion instrument, such as but not limited to officers and/or agents of each signing a contract. This enables the business organization to include 340 the entity as a distributor in a distributor position.

Where the distributor does not desire a promotion to a charter or management position, the process may end. The distributor may continue to function as a distributor under the inclusion agreement and is generally under no obligation to seek promotion.

Wherein promotion is desired, the business organization may provide 350 a promotion instrument configured to effect a promotion of the distributor to a management position. In the illustrated embodiment, the promotion instrument allows for the distributor to provide consideration, such as but not limited to cash, as a term of the promotion instrument. Accordingly, in the illustrated method, the business organization receives 360 consideration from the distributor and promotes 370 the distributor to a management/charter position. As a requirement of the management position, the entity is assigned 410 one or more responsibilities that the entity did not have as a distributor. Responsibilities may include: managing one or more distributor positions; managing resources such as supplies, equipment; managing sales revenues/profits generated by the distributors, etc. Additional managerial responsibilities may require the manager to distribute an additional portion of the sales revenue/profit to the MLM business organization 150 so as to cover overhead costs and investments and facilitate expansion and growth of the MLM business organization.

Further, the entity is provided 420 an increased access to value, such as but not limited to access to potential revenue. As the business organization performs its business through managers and distributors, the business organization realizes revenue and may distribute 430 consideration to distributor and/or management positions as indicated by agreement.

FIG. 5 illustrates a block diagram of a management structure according to one embodiment of the invention. There is shown a plurality of management/charter positions 510-570 that are related one to another according to the illustrated structure. In one embodiment, the illustrated structure represents a distribution model for down-line revenue sharing. In one embodiment, the illustrated structure represents a responsibility model outlining shared responsibilities. The illustrated structure includes three ranks: Top, Middle, and Lower.

In one embodiment, the illustrated management positions are empty and available for distributors to be promoted thereto, by purchase or otherwise. In another embodiment, one or more positions may be filled upon creation, such as but not limited to an owner filling the top management position 510 to reflect his interest in the business organization.

More, lower management positions may be related to further lower ranked management positions and/or to distributor positions, wherein such represent a down-line of a management position. For example, middle management position 520 includes positions 540 and 550 in its down-line as well as any positions in the down-lines of each of 540 and 550.

Different positions may function according to different parameters. There may be different volume requirements for different positions or ranks. In one non-limiting example, a top management position 510 may have a volume requirement of 50,000 units per month with a 5% share in revenues contingent on meeting the volume requirements; middle management positions 520 and 530 may have volume requirements of 25,000 units and have a 4% share; and lower management positions 540-570 may have volume requirements of 12,500 units and have a 3% share. Accordingly, charter members may assist one another in reaching requirements and may share in revenue generated thereby. Charter members are required to actively participate in such positions and such positions are not merely passive investments.

Wherein a business organization has particular goals for growth, expansion, etc. these goals may be realized through the present invention. For example, wherein a business organization needs $1,000,000 for projected growth, a structure may be designed such that $1,000,000 or more may be generated by promotion of members to empty charter positions. For example, there may be a single charter position available for $1,000,000. In another example, there may be a binary structure having 3 ranks (See FIG. 5) wherein the total value represented by promotion to each of the positions adds to $1,000,000 or more. Different positions may have different values and may participate differently. This may provide a variety of positions available, thereby increasing the options available to members for participation. Wherein the positions are filled, desired revenue goals are met.

It is understood that the above-described embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claims rather than by the foregoing description. All changes which come within the meaning and range of equivalency of the claims are to be embraced within their scope.

Although FIG. 1 illustrates the charter system 100 comprising a MLM business organization 150 having one management position 140 and two distributor positions 120, 130, it is envisioned that the arrangement of positions 120, 130, 140 may vary according to various embodiments, depending on size of the business and/or the product or service line(s) being offered to the marketplace. For example, the organization may have: three management positions and three distributor positions; two management positions and five distributor positions, etc. There may be a plurality of ranks as shown in FIG. 5, which may include more or fewer ranks as shown. Structure may be symmetrical as illustrated or may be asymmetrical.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims.

What is claimed is:

1. A charter system for purchasing a distributor position in a multi-level marketing business, comprising:
a multi-level distribution channel having a first distributor position and second distributor position that is a management position, wherein the distributor position and the management position form a business organization;
an inclusion instrument associated with the distributor position, and configured to include an entity as a distributor in the distributor position; and
a promotion instrument associated with the management position, and configured to promote the distributor from the distributor position to the management position, as a manager within the distribution channel in exchange for a user-selectable option of a consideration.

2. The charter system for purchasing a distributor position in a multi-level marketing business of claim 1, wherein the management position includes a higher level of responsibility than the distributor position and an increased access to potential revenue.

3. The charter system for purchasing a distributor position in a multi-level marketing business of claim 2, wherein the management position is unoccupied until the distributor is promoted to the management position.

4. The charter system for purchasing a distributor position in a multi-level marketing business of claim 1, wherein the inclusion instrument comprises a document requesting a first disclosure of information from the entity as a prerequisite to include the entity as a distributor.

5. The charter system for purchasing a distributor position in a multi-level marketing business of claim 3, wherein the promotion instrument comprises a document requesting a second disclosure of information from the distributor and the user-selectable option of consideration as prerequisites to promote the distributor from the distributor position to the management position.

6. The charter system for purchasing a distributor position in a multi-level marketing business of claim 4, wherein the distributor includes a business organization.

7. The charter system for purchasing a distributor position in a multi-level marketing business of claim 5, wherein the consideration comprises a user-selectable option from the group consisting of:
a predetermined amount of currency;
a predetermined amount of currency equivalent;
a performance requirement; and
a service.

8. A method of purchasing a distributor position in a business, comprising the steps of:
providing an inclusion instrument requesting a first disclosure of information from an entity;
including the entity as a distributor in a multi-level marketing business;
receiving a user-selectable option of consideration from the distributor;
promoting the distributor from a first distributor position to second distributor position that is a management position as a manager upon receipt of a promotion instrument with a requested second disclosure of information from the distributor and the selectable option of consideration;
assigning the manager a management responsibility; and
providing the manager with an increased access and control to potential revenue;

9. The method of purchasing a revenue position of claim 8, further comprising the step of:
converting a business to include a distributor position and a management position in a multi-level marketing business.

10. The method of purchasing a revenue position of claim 9, further comprising the step of:
distributing a first predetermined portion of a profit to the distributorship position and the management position in the multi-level marketing business, wherein the first predetermined portion of a profit is configured to increase a number of distributor positions and management positions.

11. The method of purchasing a revenue position of claim 10, further comprising the step of:
reinvesting a second predetermined portion of the profit into the multi-level marketing business, wherein the second predetermined portion of the profit is configured to stimulate growth of the multi-level marketing business.

12. The method of purchasing a revenue position of claim 8, wherein the user-selectable option of consideration comprises:
a predetermined amount of currency;
a predetermined amount of currency equivalent;
a performance requirement; and
a service.

13. The method of purchasing a revenue position of claim 8, wherein the management responsibility includes:
managing a distributorship position;
managing a plurality of distributorship resources
managing a revenue; and
managing a profit.

14. The method of purchasing a revenue position of claim 8, wherein the first disclosure of information and the second disclosure of information comprise documented personal information.
